(19) United States
(12) Patent Application Publication
(10) Pub. No.: US 2001/0044338 A1
(43) Pub. Date: Nov. 22, 2001

(54) Game controller

(76) Inventor: Chiu-Hao Cheng, Chung Ho City (TW)

Correspondence Address: BACON & THOMAS, PLLC, 4th Floor, 625 Slaters Lane, Alexandria, VA, 22314-1176, US

(21) Appl. No.: 09/855,780

(22) Filed: May 16, 2001

(30) Foreign Application Priority Data
May 17, 2000 (TW) 89208290

(51) Int. Cl. A63F 9/24; A63F 13/00

(52) U.S. Cl. 463/36

(57) ABSTRACT

The present invention relates to a game controller used in a gameplayer, more particularly, a game controller wherein the analogue switch, in correspondence with the pressure level of the button operation, can be programmed to enable functions of various programmable instruction outputs; the present invention, with the instruction combination being programmed to become the second instruction output of the analogue switch, improves the function on the game controller's button operation, renders more instruction outputs, thus enabling the user to avoid memorizing specified multiple button combination inputs.

### BACKGROUND OF THE INVENTION

1. Field of the Invention

The present invention relates to a game controller that enables the user to set up button instructions, more particularly, a game controller that replaces digital buttons with linear analogue buttons, thus enhancing buttons' functions with the programmable instructions able to be outputted, and enabling buttons to output various programmable instructions following different pressure levels of the button operation

2. Description of the Prior Art

With the everlasting progress of the electronic industry, all kinds of brand new electronic products are brought to light ceaselessly with better and better functions. Therefore, how to reduce sizes and production costs becomes one of the most important goals for researchers and designers, a goal that is especially crucial for producing monitoring devices having multiple switches or buttons, such as joystick controllers, hand-held game controllers and television remote controls.

For the conventional controllers to meet the operational requirements during game playing, numerous kinds of button combination are inputted, or operations of consecutively pushing single buttons programmed Therefore in the prior art, a programmable controller is already available by using single button to output a series of programmable instructions; in the embodiment thereof, the programmable instructions generated by a series of button combination were set up on certain single button in the controller, or on additional buttons of the controller.

FIG. 1 shows the programmable controller 1 in the prior art, therein the PROG button is the additional set-up button. The set-up process contains first, push the PROG button, and then push the single button that is to be set up with the desired function, followed by pushing a series of buttons that are needed to set up the desired function, and then push the PROG button to complete the set-up. For example, if the user goes through the set-up process by pushing PROG→A→[up→right→A→B]→PROG, it means that the A button is being given the function of the instructional combination [up→right→A→B]. As a result, during game play, if the A button is pushed, the controller shall output the programmable instructions [up→right→A→B] to the gameplayer. In another prior art, in order to keep the original function of the buttons, buttons P1 and P2 are added and are set up with different programmable instructions. Other than the aforementioned prior arts, there are also products containing programmable instructions set up by the manufacturers, or products enabling the user to alter the programmable instructions by changing memory cards.

FIG. 2 shows a block diagram of the electrical circuit in another prior art—-the programmable controller, wherein button 12 is a digital on/off switch, with the microprocessor 11 determining whether the electric level connecting the pin of the button be H or L, thus deciding whether the original button signal or the programmable instruction be outputted to the gameplayer. Consequently, with the foregoing prior art, the on/off mode of the digital switch is the only indication to whether the programmable instruction should be outputted

Nevertheless, all the above prior arts have drawbacks: if the original button is set up with programmable instructions out of different button combination, its original functions are to be lost, causing inconvenience during operation; if additional buttons are added to be set up with programmable instructions, the game controllers' production cost shall increase, and it also results in space-consuming when not in use, and operational complexity as well. Therefore, it becomes an issue for manufacturers as to how they can keep the number of buttons on controllers intact and add the function of receiving programmable instructions out of multiple button combinations, but at the same time, the original functions of the buttons are not to be lost, so that the user does not have to memorize the multiple button input operations.

### SUMMARY OF THE INVENTION

The main object of the present invention is to provide a game controller, wherein the programmable instructions can be outputted in correspondence with the pressure level of the button operation, thus enabling the user to output different programmable instructions by controlling the pressure level of the button operation, instead of memorizing specified multiple button combination operations

Another object of the present invention is to provide a game controller, wherein the buttons are programmable as well as having both the original functions and functions of at least one programmable instructions.

Another object of the present invention is to provide a game controller, wherein the digital buttons are replaced with linear analogue buttons, thus enabling the user to output different programmable instructions with the control of the pressure level of the button operation.

In view of the operational drawbacks and inconveniences contained in prior arts, especially concerning the increase of the production cost when adding buttons on controllers, the main object of the present invention is to replace conventional digital switches with analogue ones. A conventional digital switch has only two electrical circuits H and L, so when processing signals, either microprocessors or electrical circuits can only determine whether the default instructions should be outputted; unlike an analogue switch, which, because of its particular nature of physics, enables microprocessors or electrical circuits to read different ranges of electric level. For example, if the analogue switch's pressure levels of the button operation is divided into ranges 0 to 100, with 0 representing buttons not pushed, and 100 pushed to the fullest, whereby the microprocessors or electrical circuits can output either instructions (if the pressure level falls into 1 to 50), or instruction combinations (if the pressure level falls into 51 to 100).

The characteristics and merits in the embodiments of the present invention can be further grasped in conjunction with the detailed description and drawings below.

### BRIEF DESCRIPTION OF THE DRAWINGS

FIG. 1 is a top plan view of the prior art's programmable controller.

FIG. 2 is a block diagram of the electrical circuit of the prior art's programmable controller.

FIG. 3 is a block diagram of the electrical circuit in the embodiment of the present invention,

FIG. 4 is an electrical circuit diagram in the embodiment of the present invention.

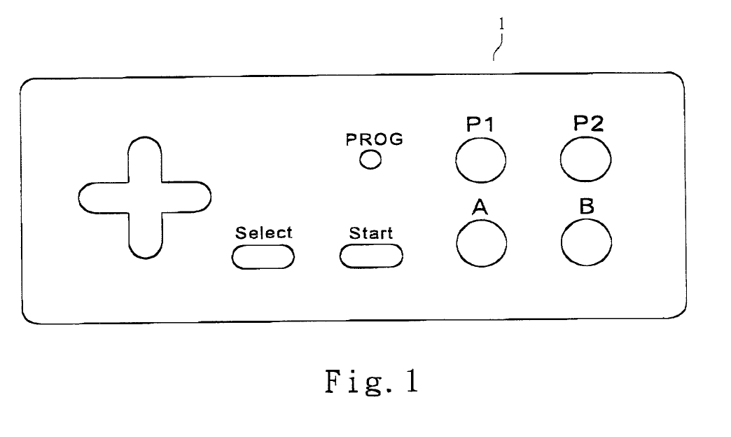

### DETAILED DESCRIPTION OF THE PREFERRED EMBODIMENTS

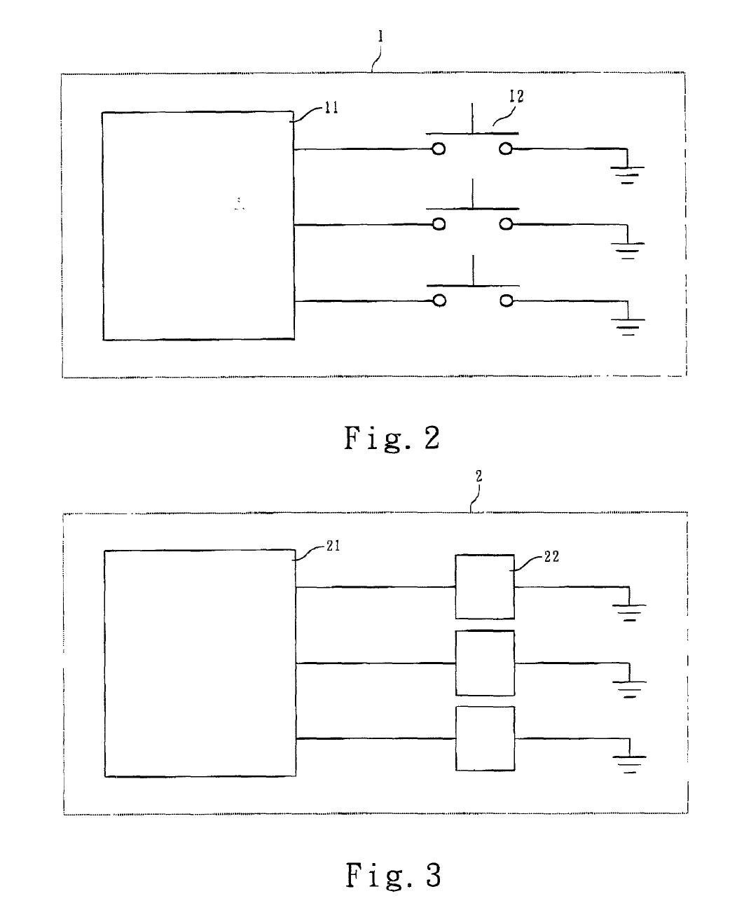

FIG. 3 shows the block diagram of the electrical circuit in the embodiment of the present invention, wherein switch 22 is an analogue switch, capable of generating constant changes of a certain physical amount under an outside force's constant operations. In the preferred embodiment of the present invention, an analogue switch is a variable register that its resistance will change under different levels of pressure, therefore when switch 22 is pushed under different levels of pressure, its resistance changes. The present invention utilizes the particular nature of switch 22, wherein the microprocessor, after receiving certain range of electric level, generates certain output of instructions, and further defines that two or more instructions be outputted with a push of button. In the embodiment of the present invention, switch 22 outputs the original instructions when receiving smaller pushing force; the instruction combinations are outputted when switch 22 receives larger pushing force. Taking the previous set-up method as an example, button A, when receiving smaller pushing force, outputs its original instruction; when receiving larger pushing force, button A outputs the previously set-up programmable instructions [up→right→A→B]. Clearly, in the embodiment of the present invention, one button can read at least two different pressure levels out of the pushing forces, thus providing more button-setup variations, for example, if button A receives even larger pushing force, it can consecutively output the programmable instruction combinations like [up→right→A→B] [up→right→A→B] [up→right→A→B]. In the other embodiment of the present invention, a button can also be set up as a combination of consecutive programmable instructions: so the button, when receiving larger pushing force, can output the programmable instructions consecutively (for the prior art to output the aforementioned signal, the button has to be repeatedly pushed and released); or a function button “Turbo” can be installed to function as the button for setting up consecutive outputs.

In another embodiment of the present invention, the function of the button PROG can be directly set up on infrequently used buttons like Start or Select. Therefore Start or Select button, when receiving a smaller pushing force, can output its original signal; if receiving a larger pushing force, it can output signals with the functions of the button PROG. As a result, the production cost for installing the extra PROG button can be further reduced.

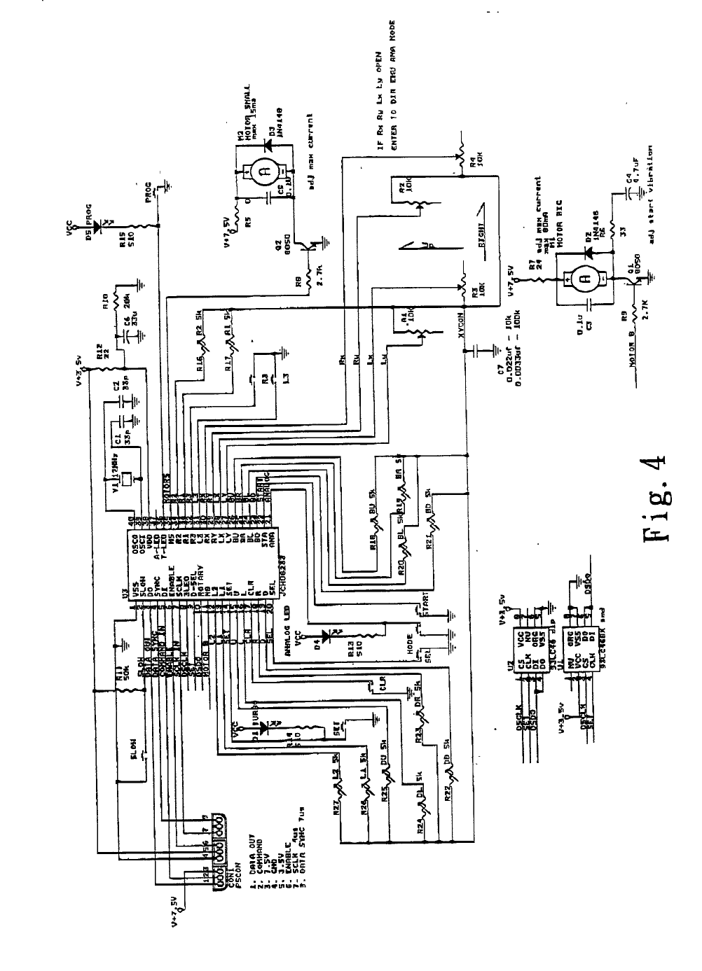

FIG. 4 shows the electrical circuit diagram in the embodiment of the present invention. In the preferred embodiment of the present invention, multiple digital switches are replaced with several analogue ones, as shown in FIG. 4, variable registers R1 to R4 and R18 to R27 are all analogue switches, whereon each operation provides the responding pins of the microprocessor 21 with different ranges of electric level, thus enabling the microprocessor 21 to output different instructions. In this embodiment of the present invention, the pins of the microprocessor 21 are designed by using variable registers in accordance with the capacitor C7 to generate different periods of electric-charging time, whereby the levels of operation can be determined; then the microprocessor 21, with its programmable control, outputs set-up instructions corresponding to the analogue switch's levels of operation Clearly, there are other circuits capable of reading the value of the electric resistance from analogue switches, like AD converter circuits, a prior art in the field. Moreover, as to the analogue switches applied-in the present invention, references can be found in the arts described in both R.O.C. Patent Application no. 89204639 and Patent no 89206816.

After the preferred embodiments of the present invention been explained in detail, it is obvious to those who skilled in the art that various modifications can be made without departing from the scope and spirit of the claims of the present invention, in addition, the embodiments of the present invention are not limited to those illustrated in this specification. For example, analogue switches are used to convert the pressure levels of the pushing force on the button to electrical signals with various amplitudes, yet it is only one of the embodiments of the present invention, and there are other converting means available, like fiber-electric conversion.

The game controller embodied in the present invention, wherein the analogue switch can be programmably set up to output different instructions, thus improving the button operation of the game controller, furnishing the game controller with set-up outputs of the instructions, and enabling the user to set up specific combinations of button instructions without replacing the button's original functions. Furthermore, the present invention lowers the production cost of the game controller by reducing the number of buttons installed, overcoming the drawbacks of the prior arts wherein the original functions of the buttons in the game controller are diminished.

What is claimed is:

1. A game controller for a gameplayer, comprising a microprocessor or an electrical circuit that contains multiple switches, and in accordance with the activity of every switch, said microprocessor or electrical circuit outputs instructions in accordance with said switch function to a gameplayer, in addition, a user can set up the activity of an assigned switch, enabling said microprocessor or electrical circuit to output instructions composed of functions of other multiple switches to said gameplayer, wherein:
said assigned switch is an analogue switch for converting various pressure levels of the button operation to electric signals with various electric levels; and
said microprocessor or electrical circuit receives said electric signals from said analogue switch, and, in accordance with various electric levels of the electric signals, correspondingly outputs said instructions of said assigned switch, or outputs said instructions composed of said functions of other multiple switches to said gameplayer.

2. A game controller as in claim 1, wherein said electric signals' electric levels from said analogue switch are proportional to said pressure levels of the button operation.

3. A game controller as in claim 1, wherein a memory device can be installed in said microprocessor or electrical circuit, and can be either set up in said game controller or in a memory card that can be inserted and retrieved.
